(19) United States
(12) Patent Application Publication
(10) Pub. No.: US 2010/0163207 A1
(43) Pub. Date: Jul. 1, 2010

(54) METHOD AND DEVICE FOR THE ELECTROMAGNETIC STIRRING OF ELECTRICALLY CONDUCTIVE FLUIDS

(75) Inventors: Petr A. Nikrityuk, Dresden (DE); Sven Eckert, Dresden (DE); Dirk Räbiger, Dresden (DE); Bernd Willers, Cossen (DE); Kerstin Eckert, Dresden (DE); Roger Grundmann, Bannewitz (DE); Gunter Gerbeth, Dresden (DE)

Correspondence Address: LERNER GREENBERG STEMER LLP, P O BOX 2480, HOLLYWOOD, FL, 33022-2480, US

(73) Assignees: FORSCHUNGSZENTRUM DRESDEN-ROSSENDORF E. V., Dresden (DE); TECHNISCHE UNIVERSITÄT DRESDEN, Dresden (DE)

(21) Appl. No.: 12/672,046

(22) PCT Filed: Aug. 1, 2008
(86) PCT No.: PCT/DE08/01261

§ 371 Date: Feb. 3, 2010

(30) Foreign Application Priority Data
Aug. 3, 2007 (DE) 10 2007 038 281.4

(51) Int. Cl. B22D 11/115; B01F 13/08; B01F 11/02

(52) U.S. Cl. 164/499; 266/99; 266/44; 366/127

(57) ABSTRACT

The invention relates to a method and a device for the electromagnetic stirring of electrically conductive fluids by using a magnetic field RMF rotating in the horizontal plane, and a magnetic field WMF traveling in a vertical direction thereto. The object consists in avoiding asymmetric flow structures in containers filled with melts, in particular at the beginning and during the course of the solidification. Moreover, the aim is to achieve an effective mixing of the fluid and/or a controlled solidification of metallic alloys by avoiding the formation of separation zones in the solidification structure. The solution consists in the fact that both the rotating magnetic field RMF and the traveling magnetic field WMF are switched on discontinuously in the form of temporally restricted and adjustable periods and alternately in time one after another via associated induction coils.

The invention relates to a method and a device for the electromagnetic stirring of electrically conductive fluids by using a magnetic field rotating in the horizontal plane, and a magnetic field traveling in a vertical direction thereto.

Because of their contactless interaction with electrically conductive fluids, time-dependent electromagnetic fields open up an attractive possibility for stirring hot metal melts or semiconductor melts. The electromagnetic force field can be directly and accurately regulated in a simple way via the parameters of magnetic field amplitude and magnetic field frequency.

Electromagnetic stirring is applied on an industrial scale, inter alia, in the directional solidification of metallic alloys or semiconductor melts. An important problem in this context consists in that flows in the immediate surroundings of an advancing solidification front can lead to separations in the solidified material that visibly impair the mechanical properties of the resulting solid body. A concentration boundary layer results at the solidification front because of the different solubility of individual components in the liquid or solid phase. Owing to the convective transport of the enriched melt away from the solidification front, a flow counteracts the formation of an extended concentration boundary layer. If the melt flows exclusively in one direction in this case, however, separation zones come about in other volume regions.

Rotating or traveling magnetic fields have already found use in metallurgical processes such as continuous casting of steel. An arrangement of a multiphase electromagnetic winding for producing a traveling field perpendicular to the casting direction in a continuous casting plant, for example, is described in publication DE AS 1 962 341.

Another method for stirring steel melt during continuous casting is described in publication US 2003/0106667 in the case of which use is made of two magnetic fields that are arranged superposed on one another and rotating in opposite senses. While the lower magnetic field takes over the actual function of stirring, the upper magnetic field has the task of braking the rotating melt in the region of the free surface to very low speed values in order to compensate for the negative effects of the stirring—a displacement and turbulence of the free surface.

A problem consists in that the operation has to make use of two magnetic stirrers—the upper magnetic stirrer with respect to the surface area and the lower magnetic stirrer with respect to the volume. The lower magnetic stirrer is used to put mechanical energy into the steel melt and to set the steel melt in rotation. However, since a far less intensive rotation of the melt is provided in the upper region of the continuous casting plant, additional energy must be expended in the upper magnetic stirrer in order to brake the flow there.

Further methods for electromagnetic stirring in continuous casting molds are described in publications DE 2 401 145 and DE 3 730 300, in which a periodic change in the current in the coil arrangement is undertaken. It is described in publication DE 2 401 145 that the formation of secondary tin strips and secondary dendrites can be avoided with the periodic change. Publication DE 3 730 300 describes a method for calming the free bath surface. It is assumed that the resulting magnetic field in the interior of the melt simultaneously maintains an intensive stirring motion. In the two publications mentioned, very wide ranges, specifically between 1 and 30 s, are specified for the cycle times in which the direction of flow is to be changed. This cycle time or period or the frequency of the change in sign of the current is an important parameter with a strong influence on the flow that forms. However, both publications specify no data with regard to a period as a function of the magnetic field strength, the geometry of the arrangement or the material properties of the metal melt.

A device and a method for intensive stirring of a melt located in a cylindrical container in the case of which a rotating magnetic field and a traveling magnetic field are simultaneously used, are described in publication JP2003220323. The rotating magnetic field is produced by a radial coil that surrounds the container and whose turns are of annular design, and the traveling magnetic field is produced by a longitudinal coil whose turns extend in an axial direction over sections of the lateral surface and overall surround the container lateral surface annularly, the longitudinal coil being arranged between the lateral surface of the container and the radial coil. The radial coil produces a rotational motion, and the longitudinal coil produces an axial motion of the liquid melt in the container. The simultaneous superposition of the two fields produces a resulting, stationary force which causes characteristic flow structures and also asymmetric flow structures in some circumstances, depending on choice of parameter. This means for the solidification that flows resulting on average over time in a mass transfer in preferred directions, and thus in separations, dominate at the solidification front.

It is the object of the invention to specify a method and a device for the electromagnetic stirring of electrically conductive fluids that are suitably designed in such a way that avoids asymmetric flow structures in containers filled with melts, in particular at the beginning and during the course of the solidification. Moreover, the aim is to achieve an effective mixing of the fluid and/or a controlled solidification of metallic alloys by avoiding the formation of separation zones in the solidification structure.

This object is achieved with the features of claims 1 and 10.

In the method for the electromagnetic stirring of electrically conductive fluids by using a magnetic field RMF rotating in the horizontal plane, and a magnetic field WMF traveling in a vertical direction thereto,

in accordance with the characterizing part of patent claim 1
both the rotating magnetic field RMF and the traveling magnetic field WMF are switched on discontinuously in the form of temporally restricted and adjustable periods T_{P,RMF} and T_{P,WMF} and alternately in time one after another.

The duration T_{P,RMF} of the periods of the rotating magnetic field RMF, and the duration T_{P,WMF} of the periods of the traveling magnetic field WMF (47) can lie in a time interval

0.2*t_{i.a.}<T_{P,RMF}=T_{P,WMF}<2·t_{i.a.} (I),

with the following definition for the initial adjustment time t_{i.a.}

$${t}_{i . a .} = {C}_{g} \cdot {( {B}_{0} \sqrt{\frac{σω}{ρ}} )}^{- 1} , \qquad ( III )$$

the variables σ, ρ, ω and B₀ denoting the electrical conductivity and the density of the fluid, the frequency and the amplitude of the magnetic field RMF or WMF, while the constant C_{g} describes the influence of the size and shape of the volume of the fluid and can assume numerical values between three and five. The initial adjustment time t_{i.a.} denotes the instant at which the volume-averaged kinetic energy of the meridional flow or the volume-averaged meridional speed U_{rz} reaches a first maximum, as described in the publication by Nikrityuk, Ungarish, Eckert, Grundmann: Spin-up of a liquid metal flow driven by a rotating magnetic field in a finite cylinder: A numerical and an analytical study, Phys Fluids 17, 067101-1 to 067101-16, 2005. The following equations hold in this case:

$$\begin{matrix}{\frac{\partial {U}_{rz}}{\partial t} \vert}_{t = {t}_{i . a .}} = 0 & ( IV ) \\ {U}_{rz} = \frac{2 {\int }_{0}^{{H}_{0}} {\int }_{0}^{{R}_{0}} \sqrt{{u}_{z}^{2} + {u}_{r}^{2}} r d r d z}{{H}_{0} {R}_{0}^{2}} . & ( V )\end{matrix}$$

In the case of the rotating magnetic field RMF, the so-called initial adjustment time t_{i.a.} is identical to the time scale in which, after a rotating magnetic field has been switched on abruptly in a melt that was previously in the state of rest, the double vortex typical of the meridional secondary flow forms.

Various periods T_{P,RMF}, T_{P,WMF} for the rotating and traveling magnetic fields can be adjusted in accordance with the following condition

0.5·T_{P,RMF}<T_{P,WMF}<5·T_{P,RMF} (II).

Metallic or semiconductor melt can be filled as electrically conductive fluid into the container.

In the state of a directional solidification under temperature control the amplitude B₀^{RMF} of the rotating magnetic field RMF is to be increased such that at least the maximum of the two values

$$\begin{matrix}{B}_{1}^{RMF} = \sqrt{\frac{ρ}{σω}} \cdot \frac{100 \cdot {V}_{sol}}{{H}_{0}} \\ and & ( VI ) \\ {B}_{2}^{RMF} = \sqrt{\frac{ρ}{σω}} \cdot \frac{40 \cdot {V}_{sol}^{3 / 2}}{\sqrt{{H}_{0} v}} & ( VII )\end{matrix}$$

is reached, the parameters v, Vₛₒₗ and H₀ representing the kinematic viscosity of the melt, the rate of solidification and the height of the melt volume. B₁^{RMF} and B₂^{RMF} are the lower limit values of the amplitudes of the rotating magnetic field, which can vary in the course of solidification as a function of the parameters v, Vₛₒₗ and H₀.

The amplitude B_{O}^{WMF} of the traveling magnetic field WMF can be set to be exactly as large as or up to four times larger than the amplitude B₀^{RMF} of the rotating magnetic field RMF, that is to say

B₀^{WMF}=1 . . . 4·B₀^{RMF} (VIII).

Other pulse shapes such as, for example, sine, triangle or sawtooth can be implemented instead of the rectangular function when modulating the profile of the Lorentz force F_{L}, the profile and the maximum value of the magnetic field RMF or WMF being defined such that an identical energy input results for the various pulse shapes.

The amplitudes B_{O}^{RMF}, B₀^{WMF} of the magnetic fields RMF or WMF can be set during the stirring in a fashion adapted continuously in accordance with the requirements derived from the process to be observed.

The individual periods T_{P,RMF} and T_{P,WMF} in which one of the magnetic fields RMF or WMF is switched on can be interrupted by a pause duration T_{Pause}, in which none of the two magnetic fields RMF or WMF act on the fluid, it being possible to set Tₚₐᵤₛₑ≦0.5·T_{P,RMF} or Tₚₐᵤₛₑ≦0.5·T_{P,WMF}.

The direction of the rotating magnetic field RMF and/or WMF can be inverted between two pulses.

The device for the electromagnetic stirring of electrically conductive fluids comprises at least
a cylindrical container,
a centrally symmetrical arrangement, surrounding the container, of at least three pairs of induction coils for forming a magnetic field RMF rotating in the horizontal plane and producing a Lorentz force F_{L}, and
an arrangement, surrounding the container, of at least two induction coils lined up one above another in a stack in order to form a magnetic field WMF traveling in a vertical direction, and
at least one temperature sensor for measuring the temperature of the fluid in the container and controlling the temperature by means of a control/regulation unit,
   in which in accordance with the characterizing part of patent claim 10
   a power supply unit is connected to the induction coils by the control/regulation unit, the power supply to the respectively associated induction coils being performed in a fashion set by the prescribed conditions

0.2·t_{i.a.}<T_{P,RMF}=T_{P,WMF}<2·t_{i.a.} (I) or

0.5·T_{P,RMF}<T_{P,WMF}<5·T_{P,RMF} (II).

The container with the fluid or liquid melt can be arranged concentrically inside the induction coils.

The container can be provided with a heating device and/or cooling device.

The baseplate of the container can be in direct contact with a solid metal body through whose interior a coolant flows.

The side walls of the container can be thermally insulated.

The cooling body can be connected to a thermostat.

A liquid metal film can be located between the cooling body and the container in order to attain a stable heat transfer in conjunction with a low transfer resistance.

The liquid metal film can consist of a gallium alloy.

Positioned in the baseplate and/or in/on the side walls of the container in which the melt is located can be at least one temperature sensor in the form of a thermocouple that supplies an information item relating to the instant of the beginning of the solidification, and is connected to the control/regulation unit for the purpose of controlling the temperature of the fluid.

A use of the device for the electromagnetic stirring of electrically conductive fluids as claimed in claims 10 to 18 can take place in the form of metallic melts in metallurgical processes, or in the form of semiconductor melts in crystal growth, for the purpose of cleaning metal melts, during continuous casting or in the process of the solidification of metallic materials by means of the method as claimed in claims 1 to 9.

In the inventive method for the electromagnetic stirring of electrically conductive fluids, both the rotating magnetic field and the magnetic field traveling in a vertical direction thereto, RMF and WMF, are switched on discontinuously in the form of temporally restricted pulses, the two magnetic fields RMF and WMF being switched on alternately and one after another in time. The induction coil pairs fed with a three-phase alternating current are thus driven in such a way that at any time one magnetic field RMF or WMF acts on the melt.

The period T_{P,RMF} of the rotating magnetic field RMF, and the period T_{P,WMF} of the traveling magnetic field WMF can be adjusted to an equal value, and there is according to the invention an adjustment according to the following condition

0.2*t_{i.a.}<T_{P,RMF}=T_{P,WMF}<2·t_{i.a.} (I),

If the period T_{P,RMF} of the rotating magnetic field RMF and the period T_{P,WMF} of the traveling magnetic field WMF are adjusted to values different from one another, an adjustment is then performed according to the following condition:

0.5·T_{P,RMF}<T_{P,WMF}<5·T_{P,RMF} (II).

The period T_{P,WMF} of the traveling magnetic field WMF is preferably longer or longer by a multiple in order to achieve an intensive mixing.

The amplitude B_{P,WMF} of the vertically traveling magnetic field WMF can be at least exactly as large as the amplitude B_{P,RMF} of the rotating magnetic field RMF, preferably being larger by a multiple (at most 4 times).

The invention is explained in more detail with the aid of an exemplary embodiment by means of a plurality of drawings, in which:

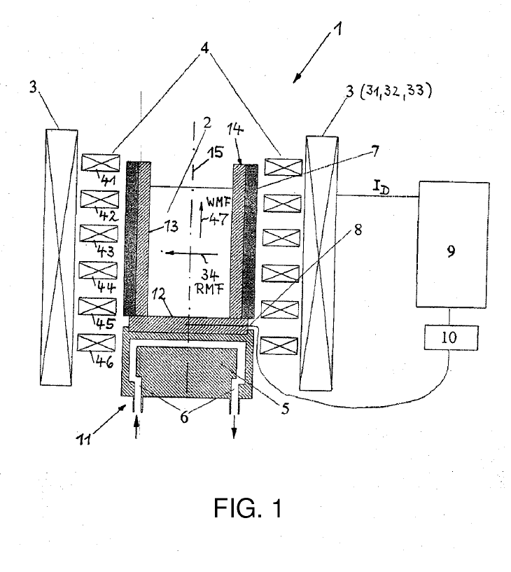

FIG. 1 is a schematic of a device for the electromagnetic stirring of electrically conductive fluids with combined magnetic fields,

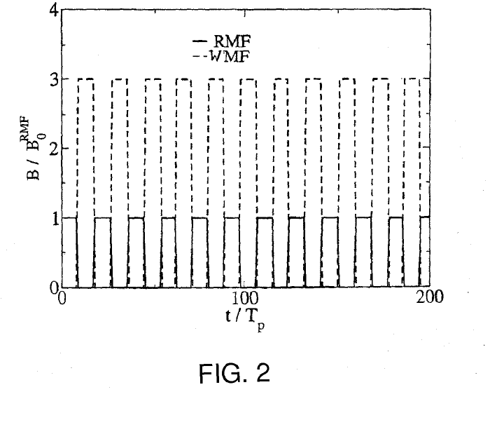

FIG. 2 is a schematic of modulation between the magnetic fields RMF and WMF in the form of a (B/B₀)−(t/Tₚ) diagram between a relative rotating magnetic field B/B₀^{RMF}=1 and a relative traveling magnetic field B/B₀^{WMF}=3 and relative period t/T_{P}, respectively,

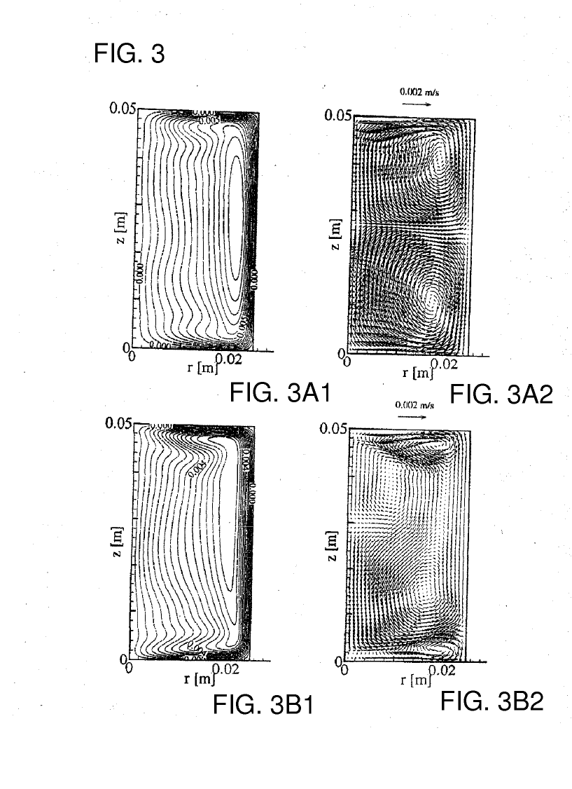

FIG. 3 comprises schematic instantaneous images of the fluid flows for B₀^{RMF}/B₀^{WMF}=1.67, Ta=1.06*10⁵, T_{P}=8.6 s=0.5*t_{i.a.}, wherein

$$Ta = \frac{σ {B}_{0}^{2} ω {R}_{0}^{4}}{2 μ v}$$

represents the Taylor number, and

FIG. 3a1 shows an instantaneous image of the azimuthal flow when the rotating magnetic field RMF is switched on and, at the same time, the traveling magnetic field WMF is switched off,

FIG. 3a2 shows an instantaneous image of the meridional speed as a vector diagram when the rotating magnetic field RMF is switched on, and at the same time, the traveling magnetic field WMF is switched off,

FIG. 3b1 shows an instantaneous image of the azimuthal flow when the traveling magnetic field WMF is switched on and, at the same time, the rotating magnetic field RMF is switched off,

FIG. 3b2 shows an instantaneous image of the meridional speed as a vector diagram when the traveling magnetic field WMF is switched on and, at the same time, the rotating magnetic field RMF is switched off,

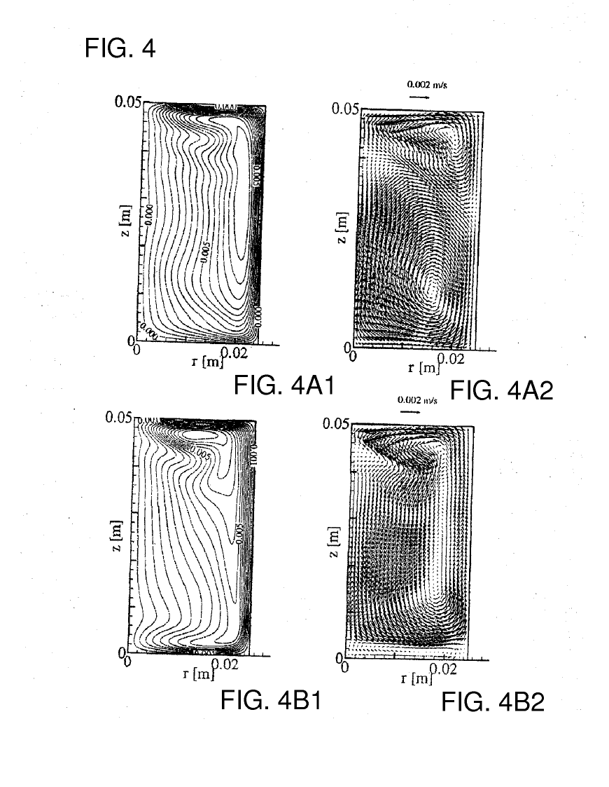

FIG. 4 comprises schematic instantaneous images of the fluid flows for B₀^{RMF}/B₀^{WMF}=3, Ta=1.06*10⁵, T_{P}=8.6 s=0.5*t_{i.a.}, wherein

FIG. 4a1 shows an instantaneous image of the azimuthal flow when the rotating magnetic field RMF is switched on and, at the same time, the traveling magnetic field WMF is switched off,

FIG. 4a2 shows an instantaneous image of the meridional speed as a vector diagram when the rotating magnetic field RMF is switched on and, at the same time, the traveling magnetic field WMF is switched off,

FIG. 4b1 shows an instantaneous image of the azimuthal flow when the traveling magnetic field WMF is switched on and, at the same time, the rotating magnetic field RMF is switched off,

FIG. 4b2 shows an instantaneous image of the meridional speed as a vector diagram when the traveling magnetic field WMF is switched on and, at the same time, the rotating magnetic field RMF is switched off.

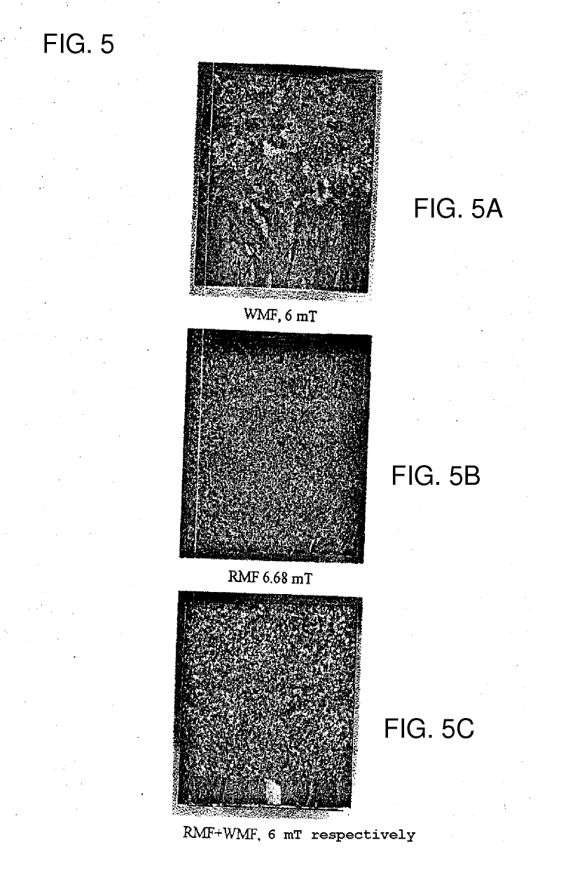

FIG. 5 shows a plurality of schematics of the solidification of an Al—Si alloy under the influence of a magnetic field-macrostructure, the appropriate magnetic fields being switched on 30 s after the beginning of solidification,

wherein

FIG. 5a shows a macrostructure under the influence of a continuously acting traveling magnetic field WMF of 6 mT,

FIG. 5b shows a macrostructure under the influence of a continuously acting rotating magnetic field RMF of 6.5 mT, and

FIG. 5c shows a macrostructure under the influence of the discontinuously and alternately acting magnetic fields RMF and WMF with 6 mT, respectively.

FIG. 1 shows a schematic of a device 1 for the electromagnetic stirring of electrically conductive fluids 2 that comprises at least
a cylindrical container 14,
a centrally symmetrical arrangement 3, surrounding the container 14, of at least three pairs 31, 32, 33 of induction coils for forming a magnetic field RMF 34 rotating in the horizontal plane and producing a Lorentz force F_{L}, and
an arrangement 4, surrounding the container 14, of induction coils 41, 42, 43, 44, 45, 46, surrounding the axis of symmetry 15 coaxially and lined up one above another in a stack, for forming a magnetic field WMF 47 traveling in a vertical direction, and
at least one temperature sensor 8 for measuring the temperature of the fluid 2 in the container 14 and controlling the temperature by means of a control/regulation unit 10.

According to the invention, the power supply unit 9 is connected to the respectively associated induction coils 31, 32, 33; 41, 42, 43, 44, 45, 46 by the control/regulation unit 10, a power supply to the induction coils 31, 32, 33; 41, 42, 43, 44, 45, 46 being performed in a fashion set by the prescribed conditions

0.2·t_{i.a.}<T_{P,RMF}=T_{P,WMF}<2·t_{i.a.} (I) or

0.5·T_{P,RMF}<T_{P,WMF}<5·T_{P,RMF} (II).

The container 14 is located in a centrally symmetrical fashion inside an arrangement 3 of pairs 31, 32, 33 of induction coils for producing a rotating magnetic field RMF 34, and an arrangement 4 of induction coils 41, 42, 43, 44, 45, 46 of a traveling magnetic field WMF 47. The induction coil pairs 31, 32, 33 and the induction coils 41, 42, 43, 44, 45, 46 lined up one above another in a stack coaxially with the axis of symmetry 15 are respectively connected to the power supply unit 9 and are fed from there with a current I_{D} in the form of a 3-phase alternating current and produce a horizontally aligned magnetic field RMF 34, rotating about the axis of symmetry 15 of the device 1, or a magnetic field WMF 47 aligned along the axis of symmetry 15 and traveling in a vertical direction. The power supply unit 9 is connected to the electronic control/regulation unit 10, which switches the 3-phase alternating current I_{D} on and off at prescribed intervals. Switching the magnetic fields RMF 34 and WMF 47 on and off is controlled by the control/regulation unit 10 such that at any time only at most one magnetic field RMF 34 or WMF 47 acts on the melt 2.

The device 1 of the cylindrical container 14 filled with the electrically conductive melt 2 can be supplemented with a cooling device 11 for the solidification of metallic melts 2. The cooling device 11 comprises a metal block 5 in the interior of which cooling channels 6 are present. The container 14 rests with its baseplate 12 on the metal block 5. During the solidification process, a coolant flows through the cooling channels 6 located in the interior of the metal block 5. The heat is withdrawn downward from the melt 2 by means of the cooling device 11. A thermal insulation 7 of the container 14 prevents heat losses in a radial direction. At least one temperature sensor 8 is fitted on the baseplate 12 and/or in/on the side walls 13 of the container 14, for example in the form of a thermocouple for the purposes of monitoring the temperature. The temperature measurements enable the liquid state, the beginning and the course of the state of solidification to be monitored, and enable an immediate adaptation of the magnetic field parameters, for example B₀^{RMF}, B₀^{WMF} and the period T_{P}, to the individual stages of the solidification process by the power supply unit 9 controlled by means of the control/regulation unit 10.

The container 14 with the melt 2 is arranged concentrically inside the induction coils 31, 32, 33; 41, 42, 43, 44, 45, 46.

The container 14 can be provided with a heating device and/or cooling device 11.

The baseplate 12 is in direct contact with a solid metal body 5 through whose interior a coolant flows.

The side walls 13 of the container 14 are thermally insulated by an insulation jacket 7.

The cooling body 5 is connected to a thermostat (not depicted).

A liquid metal film (not depicted) can be located between the cooling body 5 and the container 14 in order to attain a stable heat transfer in conjunction with a low transfer resistance.

The liquid metal film can consist of a gallium alloy.

Positioned in the baseplate 12 and/or in/on the side walls 13 of the container 14 in which the melt 2 is located is a temperature sensor 8 in the form of a thermocouple that supplies an information item relating to the instant of the beginning of the solidification, and is connected to the control/regulation unit 10.

FIG. 2 illustrates a scheme for the modulation RMF-WMF in the form of a diagram between a relative rotating magnetic field B/B₀^{RMF}=1 and a relative traveling magnetic field B/B₀^{WMF}=3 and a relative period t/T_{P}. This example respectively illustrates the temporal sequence of RMF and WMF, the amplitude of the traveling magnetic field B₀^{WMF} being three times the amplitude of the rotating magnetic field B₀^{RMF}, and equal periods T_{P,RMF} and T_{P,WMF} are selected.

As shown in FIG. 2, according to the invention the method for the electromagnetic stirring of electrically conductive fluid 2 by using a magnetic field RMF 34 rotating in the horizontal plane and a magnetic field WMF 47 traveling in a vertical direction produces both the rotating magnetic field RMF 34 and the traveling magnetic field WMF 47 discontinuously in the form of temporally restricted and adjustable periods T_{P,RMF} and T_{P,WMF} and alternately in time one after another.

The duration T_{P,WMF} of the periods of a rotating magnetic field RMF 34 and the duration T_{P,WMF} of the periods of a traveling magnetic field WMF 47 can lie in a time interval

0.2*t_{i.a.}<T_{P,RMF}=T_{P,WMF}<2·t_{i.a.} (I),

with the following definition for the characteristic initial adjustment time t_{i.a.}

$${t}_{i . a .} = {C}_{g} \cdot {( {B}_{0} \sqrt{\frac{σω}{ρ}} )}^{- 1} , \qquad ( III )$$

the variables σ, ρ, ω and B₀ denoting the electrical conductivity and the density of the fluid, the frequency and the amplitude of the magnetic field RMF and WMF, while the constant C_{g} describes the influence of the size and shape of the volume of the fluid and can assume numerical values between three and five. The initial adjustment time t_{i.a}. denotes the instant at which the volume-averaged kinetic energy of the meridional flow or the volume-averaged meridional speed U_{rz} reaches a first maximum.

Given the presence of different periods T_{P,RMF}, T_{P,WMF} for the rotating magnetic field RMF 34 and the traveling magnetic field WMF 47, it is possible to make the setting in accordance with the following condition

0.5·T_{P,RMF}<T_{P,WMF}<5·T_{P,RMF} (II).

In the state of a directional solidification under temperature control, the amplitude B₀^{RMF} of the rotating magnetic field RMF 34 is to be increased such that at least the maximum of the two values

$$\begin{matrix}{B}_{1}^{RMF} = \sqrt{\frac{ρ}{σω}} \cdot \frac{100 \cdot {V}_{sol}}{{H}_{0}} \\ and & ( VI ) \\ {B}_{2}^{RMF} = \sqrt{\frac{ρ}{σω}} \cdot \frac{40 \cdot {V}_{sol}^{3 / 2}}{\sqrt{{H}_{0} v}} & ( VII )\end{matrix}$$

are reached, parameters v, Vₛₒₗ and H₀ representing the kinematic viscosity of the melt 2, the rate of solidification and the height of the melt volume.

The amplitude B_{O}^{WMF} of the traveling magnetic field WMF 47 can be set to be exactly as large as or up to four times larger than the amplitude B₀^{RMF} of the rotating magnetic field RMF 34, that is to say

B₀^{WMF}=1 . . . 4·B₀^{RMF} (VIII).

The amplitudes B₀^{RMF}, B₀^{WMF} of the magnetic fields RMF 34 and WMF 47 can be adapted during the stirring continuously in accordance with the requirements derived from the process to be observed.

The individual periods T_{P,RMF}, T_{P,WMF} in which one of the magnetic fields RMF 34 or WMF 47 is switched on can be interrupted by a pause duration T_{Pause} in which none of the two magnetic fields act on the fluid 2, in which Tₚₐᵤₛₑ≦0.5·T_{P,RMF} or T_{Pause}≦0.5·T_{P,WMF}.

The direction of the rotating magnetic field RMF 34 and/or of the traveling magnetic field WMF 47 can be inverted between two pulses.

FIG. 3 shows schematic instantaneous images of the fluid flows for B₀^{RMF}/B₀^{WMF}=1.67, the Taylor number Ta=1.06*10⁵, T_{P}=8.6 s=0.5*t_{i.a.}, wherein FIG. 3a1 an instantaneous image of the azimuthal flow when the rotating magnetic field RMF 34 is switched on and, at the same time, the traveling magnetic field WMF 47 is switched off,

FIG. 3a2 an instantaneous image of the meridional speed as a vector diagram when the rotating magnetic field RMF 34 is switched on, and at the same time, the traveling magnetic field WMF 47 is switched off,

FIG. 3b1 an instantaneous image of the azimuthal flow when the traveling magnetic field WMF 47 is switched on and, at the same time, the rotating magnetic field RMF 34 is switched off, and

FIG. 3b2 an instantaneous image of the meridional speed as a vector diagram when the traveling magnetic field WMF 47 is switched on and the rotating magnetic field RMF 34 is switched off.

The comparison shows that the meridional flow at the bottom of the cylinder is weakened with the WMF 47 switched on, and this leads to a reduction in separation.

FIG. 4 shows schematics in the form of instantaneous images of the fluid flows for B₀^{RMF}/B₀^{WMF}=3, Ta=1.06*10⁵, T_{P}=8.6 s=0.5 wherein

FIG. 4a1 shows an instantaneous image of the azimuthal flow when the rotating magnetic field RMF 34 is switched on and, at the same time, the traveling magnetic field WMF 47 is switched off,

FIG. 4a2 shows an instantaneous image of the meridional speed as a vector diagram when the rotating magnetic field RMF 34 is switched on, and at the same time, the traveling magnetic field WMF 47 is switched off,

FIG. 4b1 shows an instantaneous image of the azimuthal flow when the traveling magnetic field WMF 47 is switched on and, at the same time, the rotating magnetic field RMF 34 is switched off, and

FIG. 4b2 shows an instantaneous image of the meridional speed as a vector diagram when the traveling magnetic field WMF 47 is switched on and, at the same time, the rotating magnetic field RMF 34 is switched off.

FIG. 5 shows a plurality of schematics of the solidification of an Al—Si alloy under the influence of a magnetic field in the form of the macrostructure, in vertical section, wherein

FIG. 5a illustrates a macrostructure under the influence of a continuously acting traveling magnetic field WMF 47 of 6 mT,

FIG. 5b illustrates a microstructure under the influence of a continuously acting rotating magnetic field RMF 34 of 6.5 mT, and

FIG. 5c illustrates a microstructure under the influence of the discontinuously and alternately acting magnetic fields RMF 34 and WMF 47 with 6 mT, respectively.

The corresponding magnetic fields RMF 34 and WMF 47 are switched on respectively 30 s after the beginning of the solidification at the container bottom. In the period up to the beginning of the electromagnetically driven flow, a coarse columnar structure grows parallel to the axis of symmetry of the container. A very coarse structure is to be seen in the case of the traveling magnetic field WMF 47 in FIG. 5a. After the traveling magnetic field WMF 47 is switched on, the columnar grains firstly continue to grow virtually unchanged until the transition from columnar to equiaxial growth occurs approximately in the middle of the sample. In the case of the continuously acting rotating magnetic field RWF 34 in FIG. 5b, a modified columnar structure is firstly formed, that is to say the columnar grains become finer and grow in a fashion inclined to the side. A transition in morphology from columnar to equiaxial grain growth is to be observed in the middle of the sample. At the solidification front, the secondary flow transports Si-rich melt toward the axis of symmetry 15. This leads to typical separation patterns that exhibit an impoverishment of eutectic phases in the edge zones, and a concentration in the region of the axis of symmetry 15. If, as shown in FIG. 5c, the rotating magnetic field RMF 34 and the traveling magnetic field WMF 47 are applied discontinuously one after another, a transition from coarse grained columnar growth to fine grained equiaxial growth is to be observed immediately with activation of the electromagnetic stirring. Separations cannot be demonstrated.

The following advantages are achieved by the invention:
In the directional solidification no flows dominate at the solidification front that cause substance transport in preferred directions on average over time.
Consequently, no undesired separation zones are formed that impair the mechanical properties.
A very good mixing of the metal or semiconductor melt can be demonstrated without separations.
An economical energy input for the stirring and mixing process is achieved.
Results that can be achieved are obtained in the inventively defined periods for the magnetic field RMF 34 rotating in a horizontal plane and the vertically traveling magnetic field WMF 47.

### LIST OF REFERENCE NUMERALS

1 Device
2 Fluid
3 Arrangement of pairs of induction coils
31 First pair
32 Second pair
33 Third pair
34 Rotating magnetic field RMF
4 Arrangement of induction coils lined up one above another coaxially
41 First induction coil
42 Second induction coil
43 Third induction coil
44 Fourth induction coil
45 Fifth induction coil
46 Sixth induction coil
47 Traveling magnetic field WMF
5 Metal block
6 Cooling channels
7 Thermal insulation jacket
8 Temperature sensor
9 Power supply unit
10 Control/regulation unit
11 Cooling device
12 Baseplate
13 Side walls
14 Container
15 Axis of symmetry

1-19. (canceled)

20. A method for the electromagnetic stirring of electrically conductive fluids by using a magnetic field RMF rotating in the horizontal plane, and a magnetic field WMF traveling in a vertical direction thereto, wherein both the rotating magnetic field RMF and the traveling magnetic field WMF are switched on discontinuously in the form of temporally restricted and adjustable periods and alternately in time one after another via associated induction coils.

21. The method as claimed in claim 20, wherein the duration (T_{P,RMF}) of the periods of a rotating magnetic field RMF, and the duration (T_{P,WMF}) of the periods of a traveling magnetic field WMF lie in a time interval
0.2·t_{i.a.}<T_{P,RMF}=T_{P,WMF}<2·t_{i.a.} (I)
with the following definition for an initial adjustment time t_{i.a.}
$${t}_{i . a .} = {C}_{g} \cdot {( {B}_{0} \sqrt{\frac{σω}{ρ}} )}^{- 1} , \qquad ( III )$$
the variables σ, ρ, ω and B₀ representing the electrical conductivity and the density of the fluid, the frequency and the amplitude of the magnetic field RMF or WMF, and the constant C_{g} representing the influence of the size and shape of the volume of the fluid, and the initial adjustment time (t_{i.a.}) representing the instant at which the volume-averaged kinetic energy of the meridional flow or the volume-averaged meridional speed U_{rz} reaches a first maximum.

22. The method as claimed in claim 20, wherein various periods T_{P,RMF}, T_{P,WMF} for the rotating magnetic field RMF and the traveling magnetic field WMF are adjusted in accordance with the following condition
0.5·T_{P,RMF}<T_{P,WMF}<5·T_{P,RMF} (II).

23. The method as claimed in claim 20, wherein the amplitude of the rotating magnetic field RMF (34) exceed the following two values
$$\begin{matrix}{B}_{1}^{RMF} = \sqrt{\frac{ρ}{σω}} \cdot \frac{100 \cdot {V}_{sol}}{{H}_{0}} \\ and & ( VI ) \\ {B}_{2}^{RMF} = \sqrt{\frac{ρ}{σω}} \cdot \frac{40 \cdot {V}_{sol}^{3 / 2}}{\sqrt{{H}_{0} v}} , & ( VII )\end{matrix}$$
the parameters v, Vₛₒₗ and H₀ representing the kinematic viscosity of the melt, the rate of solidification and the height of the melt volume, and B₁^{RMF} and B₂^{RMF} are the lower limit values of the amplitudes of the rotating magnetic field RMF.

24. The method as claimed in claim 20, wherein the amplitude (B₀^{WMF}) of the traveling magnetic field WMF is set to be exactly as large as or up to four times larger than the amplitude (B₀^{RMF}) of the rotating magnetic field RMF, that is to say
B₀^{WMF}=1 . . . 4·B₀^{RMF} (VIII).

25. The method as claimed in claim 20, wherein other pulse shapes such as, for example, sine, triangle or sawtooth are implemented instead of the rectangular function when modulating the profile of the Lorentz force, the profile and the maximum value of the respective magnetic field RMF or WMF being defined such that an identical energy input results for the various pulse shapes.

26. The method as claimed in claim 20, wherein the amplitudes of the magnetic fields RMF and WMF is set during the stirring in a fashion adapted continuously in accordance with the requirements derived from the process to be observed.

27. The method as claimed in claim 20, wherein the individual periods in which one of the magnetic fields RMF or WMF is switched on are interrupted by a pause duration T_{Pause}, in which none of the two magnetic fields RMF or WMF act on the fluid, in which T_{Pause}≦0.5·T_{P,RMF} or T_{Pause}≦0.5·T_{P,WMF}.

28. The method as claimed in claim 20, characterized in that the direction of the rotating magnetic field RMF and/or of the traveling magnetic field WMF is inverted between two pulses.

29. A device for the electromagnetic stirring of electrically conductive fluids by using a magnetic field RMF rotating in the horizontal plane, and a magnetic field WMF traveling in a vertical direction, comprising at least
a cylindrical container,
a centrally symmetrical arrangement, surrounding the container, of at least three pairs of induction coils for forming a rotating magnetic field RMF producing a Lorentz force F_{L}, and
an arrangement, surrounding the container, of at least two induction coils lined up one above another in a stack coaxially with the axis of symmetry in order to produce the vertically traveling magnetic field WMF, and
at least one temperature sensor for measuring the temperature of the fluid in the container and controlling the temperature by means of a control/regulation unit,
wherein that a power supply unit is connected to the induction coils by the control/regulation unit, the power supply to the induction coils being performed in a fashion set by the prescribed conditions
0.2·t_{i.a.}<T_{P,RMF}=T_{P,WMF}<2·t_{i.a.} (I) or
0.5·T_{P,RMF}<T_{P,WMF}<5·T_{P,RMF} (II).

30. The device as claimed in claim 29, wherein the container with the melt is arranged concentrically inside the induction coils.

31. The device as claimed in claim 30, wherein the container is provided with a heating device and/or cooling device.

32. The device as claimed in claim 31, wherein the baseplate of the container is in direct contact with a solid metal block through whose interior a coolant flows.

33. The device as claimed in claim 29, wherein the side walls of the container are thermally insulated.

34. The device as claimed in claim 32, wherein the metal block is connected to a thermostat.

35. The device as claimed in claim 32, wherein a liquid metal film is located between the metal block and the container in order to attain a stable heat transfer in conjunction with a low transfer resistance.

36. The device as claimed in claim 35, wherein the liquid metal film consists of a gallium alloy.

37. The device as claimed in claim 29, wherein positioned in the baseplate and/or the side walls of the container in which the melt is located is at least one temperature sensor in the form of a thermocouple that supplies an information item relating to the instant of the beginning of the solidification, and is connected to the control/regulation unit for the purpose of controlling the temperature of the fluid.

38. The use of the device for the electromagnetic stirring of electrically conductive fluids as claimed in claim 29 in the form of metallic melts in metallurgical processes, or in the form of semiconductor melts in crystal growth, for the purpose of cleaning metal melts, during continuous casting or during the solidification of metallic materials by means of the method as claimed in claim 20.
